(19) United States
(12) Patent Application Publication
(10) Pub. No.: US 2007/0136172 A1
(43) Pub. Date: Jun. 14, 2007

(54) METHOD AND SYSTEM FOR CONSTRUCTION OF A PASSIVE ABSOLUTE RETURN INDEX

(76) Inventor: John M. West, Hermosa Beach, CA (US)

Correspondence Address: FOLEY & LARDNER LLP, 150 EAST GILMAN STREET, P.O. BOX 1497, MADISON, WI, 53701-1497, US

(21) Appl. No.: 11/563,501

(22) Filed: Nov. 27, 2006

Related U.S. Application Data
(60) Provisional application No. 60/748,488, filed on Dec. 8, 2005.

(51) Int. Cl. G06Q 40/00

(52) U.S. Cl. 705/36 R

(57) ABSTRACT

The methodology described herein arranges a collection of positive return streams or market “betas” where a diversified set of these return streams are available at a lower cost. The methodology combines known risk premiums and exotic betas to arrive at its results. For example, such a method of identifying eligible investments for inclusion in an investment fund can include selecting a first investment and a second investment; determining whether the first investment and the second investment provide positive, historical excess return streams; assessing a correlation between the first investment and the second correlation; and identifying a representative index and vehicle for the first and second investments if the assessed correlation is at or below a predetermined low correlation level.

### RELATED APPLICATIONS

The present application claims priority to U.S. Provisional Patent Application No. 60/748,488, filed on Dec. 8, 2005, and titled “METHOD AND SYSTEM FOR CONSTRUCTION OF A PASSIVE ABSOLUTE RETURN INDEX,” the disclosure of which is incorporated herein by reference in its entirety.

### BACKGROUND

Absolute return investing refers to a range of investment strategies that either alone, or in conjunction, target relatively predictable, consistent (and positive) returns. The purpose of absolute return investing is to generate positive returns, regardless of market conditions. Risk for absolute return investing focuses on loss of capital, not underperforming of a benchmark. There is a need for improved methods and systems of absolute return investing. Furthermore, there is a need for methods and systems of constructing a passive absolute return index.

### BRIEF SUMMARY

By way of example, the methodology described herein arranges a collection of positive return streams or market “betas” where a diversified set of these return streams are available at a lower cost. The methodology combines known risk premiums and exotic betas to arrive at its results.

An exemplary method of identifying eligible investments for inclusion in an investment fund can include selecting a first investment and a second investment; determining whether the first investment and the second investment provide positive, historical excess return streams; assessing a correlation between the first investment and the second investment; and identifying a representative index and vehicle for the first and second investment if the assessed correlation is at or below a predetermined low correlation level.

### BRIEF DESCRIPTION OF THE DRAWINGS

FIG. 1 is a depiction of a process of identifying investments.

FIG. 2 is a depiction of a process of investment portfolio management.

FIG. 3 is a chart of portfolio standard deviation compared to number of portfolio investment opportunities.

FIG. 4 is a correlation table for an exemplary diversified premia return series.

FIG. 5 is a computer system used to implement exemplary embodiments.

### DETAILED DESCRIPTION

Introduction.

The capital asset pricing model (CAPM) states that returns on any given portfolio can be broken down into three components:
E(R)=Rf+Beta*(Rm−Rf)+Alpha

Risk Free Rate (Rf) is the return available by taking no investment risk. Money market or Treasury Bills are a standard measure of the risk free rate.

Beta is a portfolio's sensitivity to the market. A beta of 1.0 implies that a portfolio will rise and fall exactly in proportion to the market. On the conservative side, a beta of 0.8 implies the portfolio will only experience 80% of the rise or fall of the market.

Return of the Market (Rm)—The “market” in which the portfolio or security is included with the return being measured by some broad-based index.

Alpha is the error term. In other words, it is the return of the portfolio that isn't explained by market factors or the risk free rate—any leftover amount is attributed to manager skill, or alpha.

The investor can do little to influence the risk free rate and the return of the market, leaving two remaining sources of return that the investor can attempt to control: beta and alpha. Increasing the beta of the portfolio increases its sensitivity to market fluctuations, essentially adding risk. By taking this economic risk, the investor would expect to be compensated. This compensation takes the form of a risk premium. To better understand risk premiums, take the standard investor choices:

Cash—Money market instruments essentially offer the risk-free rate. Hence, the possibility of loss and volatility of returns are minimal.

Bonds—Bonds are riskier than cash as 5, 10, or 30 year bonds expose investors to 5, 10, or 30 years of interest rate movements and potential short-term losses. Investors demand a premium over cash to compensate for these risks.

Stocks—Equities are, of course, riskier than bonds. They have economic risks that should be rewarded with higher returns. They fall below bonds on the bankruptcy food chain and offer less yield. For these reasons, they have a greater amount of market risk, which can be quantified through the increased annual volatility.

For investors seeking more return from their portfolio, beta offers several advantages. First, beta is easy to implement. In a traditional balanced stock and bond portfolio, beta is increased by simply adding stocks and reducing bonds. Second, beta is inexpensive. Stock exposure can be achieved through a low cost S & P 500 Index fund. Third, beta is easy to monitor. An index fund requires little ongoing due diligence. Fourth, beta is unconditionally rewarded over longer periods as long as the market is rational.

Alpha is quite the opposite of beta. It is solely dependent on manager skill—the ability of a security analyst to outperform the market at the same level of risk. In a complex and competitive market, manager skill is an increasingly difficult, if not impossible attribute to measure. For example there are a large numbers of mutual funds run by talented professionals that are unable to beat the return of a simple unmanaged index. For an investor seeking more return, alpha is tempting but often very difficult to determine.

First, alpha is difficult to implement. Searching for talented organizations amongst the thousands of investment firms requires considerable resources. Furthermore, yesterday's winners are just as likely to underperform as past performance is a notoriously bad predictor of future results. Second, determining alpha is expensive. Active investment managers retain considerable human capital to conduct research, for example. Third, alpha can be costly to monitor. Once hired, an investment manager must be monitored. Large amounts of performance and attribution data must be analyzed. Assessing qualitative developments such as portfolio manager turnover and organizational changes also translates to additional time and resources. Further, alpha is conditionally rewarded. If you find the right manager, the investor over long periods will receive benefits of active management.

Beta risk is preferably taken in order to produce a passive portfolio with a positive expected rate of return. As such, the identification of systematic risk premiums or betas is a first step in building such a portfolio. Currently, many investors believe that returns from traditional asset classes like stocks and bonds will be lower than what is required to satisfy most institutional liabilities. Instead of lowering expectations and enduring the associated belt-tightening, many institutions search to eliminate this deficit through the location of alpha. However, talking about, and pursuing alpha does not imply it will be found —it is a zero sum game regardless of whether it is sought in a traditional or alternative structure like hedge funds. Before fees, half of these alpha seekers are rewarded and half are not. The number of losers in this new alternative alpha game increases dramatically after the layers of fees are subtracted.

Ten or fifteen years ago, hedge funds enjoyed a considerably more favorable market for their multi-disciplined profit making because traditional managers were constrained by restrictive guidelines, institutions were unwilling to short-sell, many were ignorant of merger arbitrage or convertible arbitrage, etc. Over time, the competitive environment of hedge funds changed. Now, seven thousand hedge funds manage a collective $1 trillion today. The mega pension plans and mutual fund companies that used to be on the losing side of hedge fund trades are now hedge fund investors themselves. This market evolution is not unlike what happened to traditional stock and bond managers thirty years ago. As the institutions became the market, they began to trade amongst themselves. Once institutions became the market, the institutions couldn't collectively outperform themselves. Half had to win and half had to lose, before fees. Not long after, the index fund became a household word.

If this history of market evolution repeats itself and the hedge fund market becomes saturated with participants, investors relying on alphas will struggle to achieve positive results. The exemplary methods described herein may achieve excess returns in this saturated hedge fund market. The exemplary methods re-engineer a collection of positive return streams or market betas. Unlike hedge funds, a diversified set of these return streams can be made available at a significantly smaller cost leaving more of the remaining premium available to the investor. Furthermore, the exemplary methods should be relatively immune to the deprivation of returns due to asset flows currently being experienced in hedge fund strategies.

Exemplary Methods.

A positive excess return can be achieved by prudently allocating to a diversified, uncorrelated set of positive return streams based upon known risk premia. In an exemplary embodiment, each of the return streams should preferably display the following characteristics:
1. Long-term positive expected excess return above the risk-free rate.
2. An economic, behavioral or structural rationale for such a positive excess return.
3. Low correlation to one another.
4. Low correlation to the equity market as measured by the S & P 500.

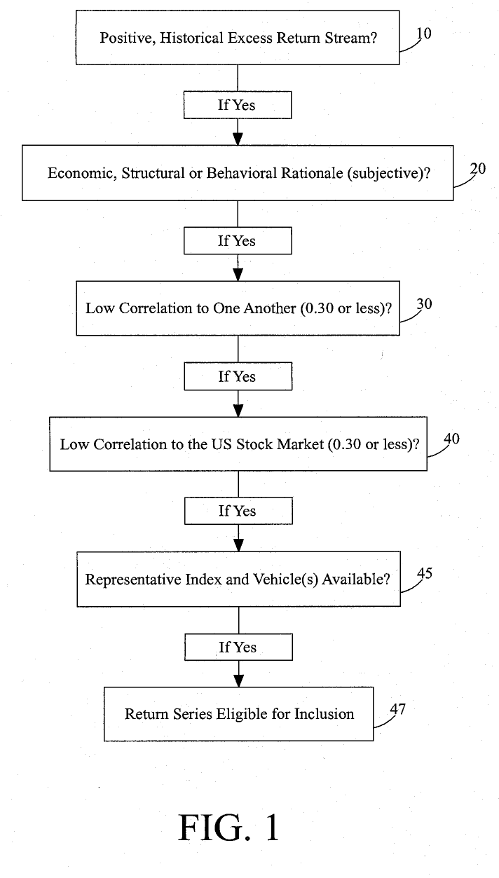

FIG. 1 illustrates an exemplary process of identifying investments according to these aforementioned characteristics. Operations depicted in this process are illustrative only. Additional, fewer, or different operations may be performed and the operations may be performed in a different order. In an operation 10, an investment is examined to assess whether it has a positive, historical excess return stream. To do so, historical returns of a representative benchmark or index are calculated and summarized using a software product or module on a computer. Each investment's return is adjusted for risk with this software product or module, utilizing a risk-adjusted measure of return such as the Sharpe Ratio. The investment is analyzed to determine the economic, structural, or behavioral rationale for the investment in an operation 20. A practitioner applies a qualitative screening process which can consist of a number of questions to determine why the investment has and will continue to display positive excess returns. Any investment that earns a positive or “yes” response after sound and deliberate analysis is eligible for inclusion. These questions fall under three broad categories labeled economic, structural or behavioral. To earn a “yes” on economic rationale, the investment must produce a positive excess return stream because it is taking a risk for which a rational investor would expect to be compensated. To earn a “yes” on structural rationale, the investment must produce a positive excess return stream because it is taking advantage of some flawed market structure (like institutional guidelines) that prevents rational distribution of investment opportunities. To earn a “yes” on behavioral rationale, the investment must produce a positive excess return stream because it is taking advantage of some prevalent cognitive biases of other investors. In an operation 30, the investment is compared to other investments successfully satisfying conditions of operations 10 and 20 to find a series or grouping of investments with positive results in operations 10 and 20 for which there is low correlation to one another (e.g., a correlation of 0.30 or less). In an operation 40, the investments are examined to identify investments with low correlation compared to the U.S. Stock Market (e.g., 0.30 or less). For investments meeting requirements in operations 10, 20, 30 and 40, a representative index and vehicle is sought in an operation 45. The representative index should capture and be representative (i.e., the S&P 500 Index for large company U.S. stocks) of the investments in operation 10. The index may be the same in operation 10 or it may be different. The vehicle is the type of security utilized to obtain the returns of the investment such as swaps, futures, or exchange traded funds (EFT's). The selected vehicle will have the most ideal combination of cost and liquidity. If such an index and vehicle is available, the investment series is returned in an operation 47 as in the investment group.

By way of example, academic research suggests that value stocks return more than growth stocks. To obtain exposure to the value premium, growth stocks are shorted in the form of Russell 1000 Growth iShares and, with the proceeds of the short sale, value exposure is purchased through Russell 1000 Value iShares. A historical example of this premium is provided below in Table 1 (exclusive of transaction and management costs).

TABLE 1

| | Russell 1000 | Russell 1000 | Value |
|---|---|---|---|
| | Growth | Value | Premium |
| 1991 | 41.2 | 24.6 | −11.7% |
| 1992 | 5.0 | 13.8 | 8.4% |
| 1993 | 2.9 | 18.1 | 14.8% |
| 1994 | 2.7 | −2.0 | −4.5% |
| 1995 | 37.2 | 38.4 | 0.8% |
| 1996 | 23.1 | 21.6 | −1.2% |
| 1997 | 30.5 | 35.2 | 3.6% |
| 1998 | 38.7 | 15.6 | −16.6% |
| 1999 | 33.2 | 7.4 | −19.4% |
| 2000 | −22.4 | 7.0 | 37.9% |
| 2001 | −20.4 | −5.6 | 18.6% |
| 2002 | −27.9 | −15.5 | 17.2% |
| 2003 | 29.8 | 30.0 | 0.2% |
| 2004 | 6.3 | 16.5 | 9.6% |

| | |
|---|---|
| Annualized Total | 2.88% |

The same trade could be utilized for the premium displayed by small capitalization stocks relative to large capitalization shares. Similarly, a long corporate bond and short Treasury transaction would produce a projected positive excess return.

A survey of positive expected return streams was conducted. Some of these like fixed income arbitrage are modeled off of similar trades implemented by hedge funds. The return streams identified in this example study are summarized in Table 2.

TABLE 2

| | | Premium | |
|---|---|---|---|
| Stream | Description | Rationale | Implementation |
| Long Short Equity - | Long value stocks, short | Economic | 33% Russell 1000 Value - R1000 |
| Value | growth stocks | and/or | Growth, 67% Russell 2000 Value - |
| | | Behavioral | Russell 2000 Growth |
| Long Short | Long Int'l Value Stocks, | Economic | MSCI EAFE Value - MSCI EAFE |
| International Equity - | Short Int'l Growth Stocks | and/or | Growth |
| Value | | Behavioral | |
| Long Short Equity - | Long last year's winners, | Behavioral | Variable - The pool consists of six |
| Momentum | short last year's losers | | indices. See Appendix A for details. |
| Long Short Equity - | Long mid cap stocks, | Economic | S & P 400 Mid Cap - S & P 500 |
| Mid Premium | Short Large Cap Stocks | | |
| Long Short Equity - | Long small cap stocks, | Economic | S & P 600 Small Cap S & P 500 |
| Small Premium | Short large cap stocks | | |
| Fixed Income | Long mortgages, credit, | Economic | 40% LB Credit TR, 50% LB Mortgage |
| Arbitrage | emerging market bonds; | | TR, 10% JPM EMBI - LB Gov't Index |
| | Short Treasuries | | |
| High Yield | Excess return of high | Economic | ML High Yield Master Index Less |
| Premium | yield above cash | and/or | Cash |
| | | Structural | |
| Convertible | Excess return of | Economic | CSFB Conv Bond TR Less Cash |
| Arbitrage | convertible bonds above | | |
| | cash | | |
| Commodities | Excess return of | Economic | DJ - AIG Commodity Index Less Cash |
| | commodities above cash | | |
| Emerging Markets | Excess return of | Economic | 50% S&P/IFCI Emerging Composite |
| | emerging market | and/or | and 50% JPM EMBI Index* Less Cash |
| | stock/bond blend above | Structural | |
| | cash | | |
| Short Maturity | Excess return of short- | Economic | LB 1-3 Yr Gvt TR Less Cash |
| Premium | term bonds above cash | and/or | |
| | | Structural | |
| Long Maturity | Excess return of long- | Economic | U.S. LT Gvt TR Less Cash |
| Premium | term bonds above cash | | |

Some of these return streams (Convertible Arbitrage, Emerging Markets, etc.) are directional, meaning that they have some underlying exposure to the direction of the “market.” Others are “non-directional” (Equity Long Short, Fixed Income Arbitrage, etc.) meaning we eliminate market exposure by shorting some variable of market exposure (interest rates, stock market direction, etc.). The breakdown of directional and non-directional strategies is listed in Table 3.

TABLE 3

| Non-Directional | Directional |
|---|---|
| Long Short Equity - Value | High Yield |
| Long Short Equity - International | Convertible Arbitrage |
| Value | |
| Long Short Equity - Momentum | Commodities |
| Long Short Equity - Mid Premium | Emerging Markets |
| Long Short Equity - Small Premium | Short Maturity Premium |
| Fixed Income Arbitrage | Long Maturity Premium |

In an exemplary embodiment, an investment series is calculated using monthly or quarterly geometric differences. Other methodologies can be used. The exact methodology is dependent upon whether the return stream is directional or non-directional. If the return stream is directional, the monthly return of each return stream minus cash (the 30-Day US T-Bill rate from Ibbotson) is calculated. These calculations are then geometrically linked to form the stream. For example, the monthly or quarterly high yield premium is given by: {(1+ML High Yield Master Total Return)/(1+30-Day US T-Bill Total Return)}−1

If the return stream is non-directional, the geometric difference of the long positions minus the short position is determined is calculated. As above, the calculation methodology can change. This difference is then geometrically linked to form the data stream. For example, the monthly small value premium is given by: {(1+Russell 2000 Value Total Return)/(1+Russell 2000 Growth Total Return)}−1

In Table 4 below, the monthly series were calculated beginning in January 1991 through December 2004. The inception of the Dow Jones—AIG Commodity Index was in 1991.

TABLE 4

| | | Geometric | Standard | Sharpe | | Correlation |
|---|---|---|---|---|---|---|
| | Periods | Mean (%) | Deviation (%) | Ratio | T-Stat | S & P 500 |
| Value Premium | 56 | 5.73 | 17.19 | 0.33 | 2.47 | −0.58 |
| Russ Large Value Premium | 56 | 3.09 | 15.04 | 0.21 | 1.52 | −0.45 |
| Russ Small Value Premium | 56 | 6.94 | 18.97 | 0.37 | 2.71 | −0.61 |
| Int'l Value Premium | 56 | 4.49 | 8.03 | 0.56 | 4.15 | −0.29 |
| Momentum Premium | 56 | 2.39 | 12.38 | 0.19 | 1.43 | −0.26 |
| 50-50 Value/Momentum | 56 | 4.55 | 10.00 | 0.46 | 3.37 | −0.65 |
| Mid Premium | 56 | 3.76 | 8.88 | 0.42 | 3.14 | 0.11 |
| Small Premium | 56 | 3.31 | 11.45 | 0.29 | 2.14 | 0.02 |
| FI Arb Comp | 56 | 1.17 | 2.86 | 0.41 | 3.03 | 0.60 |
| Convertible Arb | 56 | 6.77 | 13.64 | 0.50 | 3.68 | 0.80 |
| High Yield Premium | 56 | 6.58 | 8.25 | 0.80 | 5.91 | 0.57 |
| Short Term Premium | 56 | 1.83 | 1.98 | 0.92 | 6.85 | −0.26 |
| Long Term Premium | 56 | 5.45 | 9.45 | 0.58 | 4.28 | −0.19 |
| Commodity Premium | 56 | 2.84 | 12.01 | 0.24 | 1.75 | −0.19 |
| Emerging Market Premium | 56 | 8.18 | 21.52 | 0.38 | 2.82 | 0.59 |
| Diversified Beta | 56 | 5.02 | 3.51 | 1.43 | 10.61 | −0.11 |

The T-statistics in Table 4 indicate that for a 95% confidence interval only three series—Russell Large Value Premium, Momentum Premium, and Commodity Premium —fail to produce an average excess return reliably different than zero. Of these three series, only the Momentum Series fails to post any economic rationale for reliably generating positive excess returns. Further examination to uncover a reliable premium for excess returns through momentum-oriented index trading is required. Otherwise the series should be eliminated.

In aggregate, the return series display Sharpe ratios consistent with traditional long-only beta exposures. For example, the S & P 500 Index and Ibbotson Intermediate Term Government Bond Series Sharpe ratios were 0.47 and 0.57, respectively, over the same time horizon. As these results show, implementing any one of these strategies on its own would lead to less than impressive results. For example, shorting the Russell 2000 Value Index and using the proceeds to buy the Russell 2000 Growth Index would yield a positive excess return of 6.97% over the fourteen year evaluation period. However, the volatility incurred in earning such a premium is significant—nearly 19% annual standard deviation.

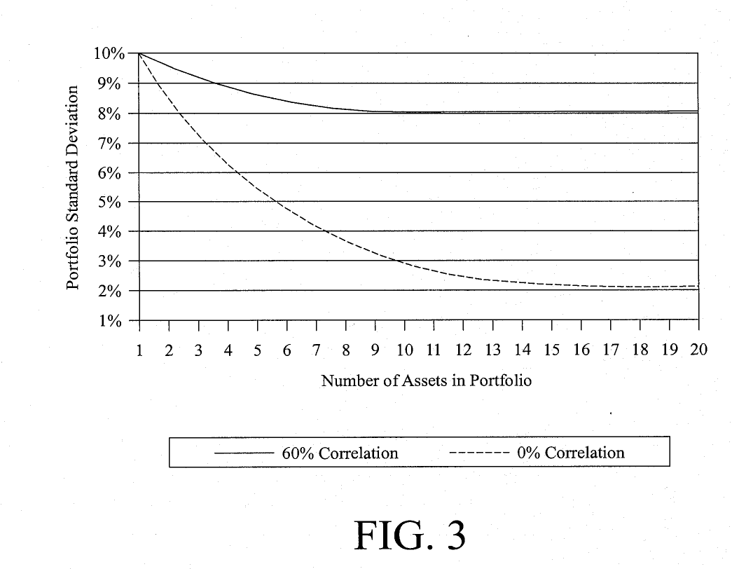

According to an exemplary embodiment, constructing a portfolio of these return series requires their correlation to one another. Combining assets with moderate correlation results in some risk reduction, but true diversification occurs at correlation levels approaching zero as the chart in FIG. 3 shows.

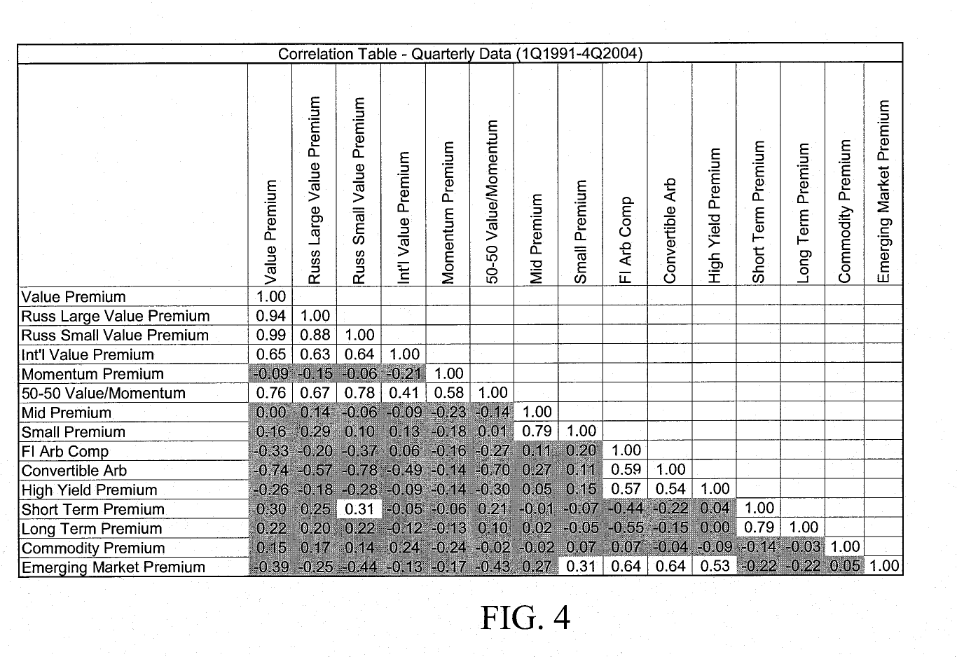

Preferably, investment series identified have low to negative correlation with one another over the fourteen year evaluation period. FIG. 4 illustrates a correlation table based upon quarterly returns for an exemplary investment series. The cross correlations in FIG. 4 that are uncorrelated are shaded, where “uncorrelated” is defined as having the same diversification that an investment grade bond portfolio (Lehman Brothers Aggregate Index) has exhibited towards equities (S & P 500 Index). This value historically approximated 0.30. The standard institutional investor weighs potential asset allocations (and the resulting risk/return implications) principally between these two asset classes.

The rationale for these low correlations are preferably examined separately for the non-directional and directional components. The non-directional series eliminate a common risk factor (equity market, interest rates) to solely produce the risk premium whereas traditional, long-only asset classes rise and fall with the tide produced by these common risk factors. The resulting investment series are not commonly affected and therefore have close to zero correlations. Meanwhile, the directional investment series are, for the most part, “exotic betas” that most institutional investors don't utilize. For purposes of this document, “exotic” in reference to betas means that the betas are market exposures or categories of investment that are not commonly utilized by investors. They are outside the traditional U.S. stock and bond framework.

The return streams are allocated using mean-variance optimization based upon expected excess returns, standard deviations and correlations. These expected statistics are solely based upon historical data (e.g., from 1991-2004). This backward look may reveal some data mining—selecting the best portfolio ex-post on the basis of results. To counter this data mining effort, an equal-weighted composite is constructed. The results are shown below in Table 5.

TABLE 5

| | | Equal |
|---|---|---|
| | Optimized | Weighted |
| Value Premium | 12.0% | 0.0% |
| Russ Large Value Premium | 0.0% | 7.7% |
| Russ Small Value Premium | 0.0% | 7.7% |
| Int'l Value Premium | 8.0% | 7.7% |
| Momentum Premium | 0.0% | 7.7% |
| 50-50 Value/Momentum | 12.0% | 0.0% |
| Mid Premium | 7.0% | 7.7% |
| Small Premium | 0.0% | 7.7% |
| FI Arb Comp | 15.0% | 7.7% |
| Convertible Arb | 8.0% | 7.7% |
| High Yield Premium | 10.0% | 7.7% |
| Short Term Premium | 10.0% | 7.7% |
| Long Term Premium | 8.0% | 7.7% |
| Commodity Premium | 5.0% | 7.7% |
| Emerging Market Premium | 5.0% | 7.7% |
| Total Non-Directional | 54.0% | 53.9% |
| Total Directional | 46.0% | 46.2% |
| Total | 100.0% | 100.0% |

Table 6 summarizes results of allocation to the exemplary investment series from 1Q1991 to 4Q2004. In both the optimized and equal-weighted versions, the investment series portfolios achieve excess returns of nearly 5%. The Sharpe Ratios displayed are over one and consistent with those found in hedge find of finds. The high Sharpe Ratio is predominately the result of the returns series low correlation to one another. As different categories are added the efficiency of the portfolio notably increases.

TABLE 6

| | | | Standard | | | |
|---|---|---|---|---|---|---|
| | | Geometric | Deviation | Sharpe | | Correlation |
| | Periods | Mean (%) | (%) | Ratio | T-Stat | S & P 500 |
| Diversified Optimized | 56 | 4.96 | 3.45 | 1.44 | 10.66 | −0.10 |
| Diversified Equal Weight | 56 | 5.10 | 3.90 | 1.31 | 9.70 | 0.00 |

The exemplary investment series is most likely to be overlaid on cash as a hedge fund substitute given the institutional world's insatiable thirst for absolute return vehicles. By simply adding the excess return of 5% to cash instruments, the returns become very competitive to those produced by hedge fund of funds. Both the Equal Weight and Optimized portfolios incurred less risk than the HFRI Hedge Fund of Fund (FOF) Composite and Conservative Indices over the fourteen year evaluation period. Furthermore, the quarterly correlations to the S & P 500 Index implies the exemplary investment series offers significantly better diversification than hedge funds for investors with large equity allocations.

The exemplary investment series offers two further advantages in its implementation by investors—portability and scalability. The excess returns of the investment series portfolio can be overlaid on any other asset class where appropriate and cost effective derivatives are available. The non-directional return series are self financing—the proceeds from the short sales can be utilized to buy the long series while the directional components could be implemented with little capital through derivatives like future and swaps. Thus, the exemplary investment series can be distributed as a portable alpha strategy for enhanced equity or bond portfolios.

The self-financing attribute also allows the investment series portfolio be “scaled” for more/less return and risk—simply increase leverage/economic exposure. For the most part, the strategy does not borrow money instead it utilizes self-funding long/short trades or derivatives, which allow for increased economic exposure with little to no degradation in information ratio of 1.3 (5.1% Return/3.9% Standard Deviation). For example, an aggressive client can request a targeted gross excess return of 10.2% above cash with a standard deviation of 7.8% while a conservative investor can utilize the investment series as a portable alpha vehicle (2.6% Return/2.0% Standard Deviation) for an enhanced equity allocation. The information ratio of 1.3 applies to all mandates.

Advantageously, two factors make the investment series a unique solution to plan sponsors interested in hedge fund promises of absolute return or the rapidly expanding use of portable alpha. The investment series portfolio should produce positive excess returns over time. The excess returns are dependent upon a basket of risky assets outperforming less risky assets. Basic economic theory and cost of capital should ensure these return streams have positive excess returns. The methodology locates risky assets that display low correlation with one another to produce consistent total portfolio returns. Simultaneously, structural or behavioral anomalies are explored for excess return opportunities. One such structural example could be poorly constructed indices versus more robust ones that represent the same asset class (i.e. Russell 2000 versus MSCI 1750 Small Cap). A behavioral positive return stream worth exploring is the propensity for higher quality (as measured by variables such as ROE, dividends, etc.) stocks to outperform lower quality shares.

The exemplary investment series strategy outlined herein addresses many of the problems previously identified with hedge funds and particularly to hedge fund of funds as absolute return vehicles. Transparency—the positions are clearly identified beforehand and easily understood before investment. If new series are discovered, investors can be informed before implementation. Leverage—The leverage utilized is explicit and expected to remain constant. Fees—Much like a traditional bond or stock index fund, the strategy requires little fundamental analysis (save in identifying additional excess return streams.) Accordingly, it will have significantly smaller management fees. Since it is a passive strategy, no investor should expect to pay a carry fee. However, implementing such a strategy does require some special skills—namely knowledge of derivatives, sophisticated trading expertise, and risk management systems. Assets Under Management—Since the strategy is collecting risk premiums that should rationally persist in the capital markets, it should be immune to the flood of assets enveloping the hedge fund space. Further, it avoids “hedge fund risk premiums” like merger arbitrage whose profit opportunities are particularly sensitive to large asset flows. Future excess return streams that are behaviorally or structurally positive (like the MSCI and Russell example) may eventually be realized by the marketplace to a point whereupon future excess returns may no longer be assured. They would of course have to be removed from the index at that juncture with appropriate communication.

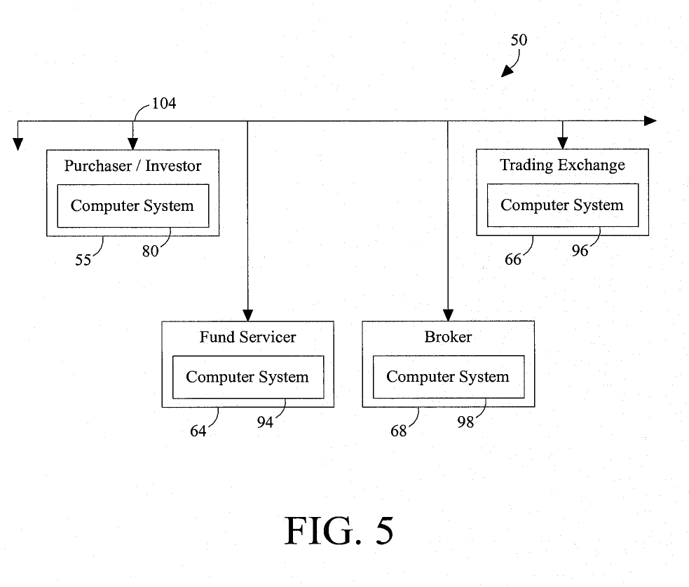

FIG. 5 illustrates a computer system 50 usable to implement various features described herein is shown. The computer system 50 can include a variety of computer subsystems, including a computer system 80 associated with a purchaser 55 of an investment fund, a computer system 94 associated with a fund servicer 64, a computer system 96 associated with a trading exchange 66, and a computer system 98 associated with a broker 68. Each of the computer systems 80-98 may comprise a single computer including a microprocessor and memory with program logic and stored data to implement the features described herein, or may comprise multiple computers which are connected together, for example, by way of a network (not shown). The computer systems 80-98 are coupled by way of a network 104, which is shown to be a single network but which may in practice comprise one or more individual point-to-point connections and/or which may comprise one or more network connections, such as the Internet.

The trading exchange computer system 96 and/or the broker computer system 98 may execute investment fund origination and/or investment fund calculation software. In one configuration, the software executed by the trading exchange computer system 96 and/or the broker computer system 98 is a web-based interface (e.g., a web browser), and the computer system 94 executes the core algorithms that provide the functionality and logic of the origination/calculation software. The calculation and origination software includes computer code that executes instructions to receive information to be used in creation and updating of an investment fund, including determining investments to include in the fund and returns made by the fund.

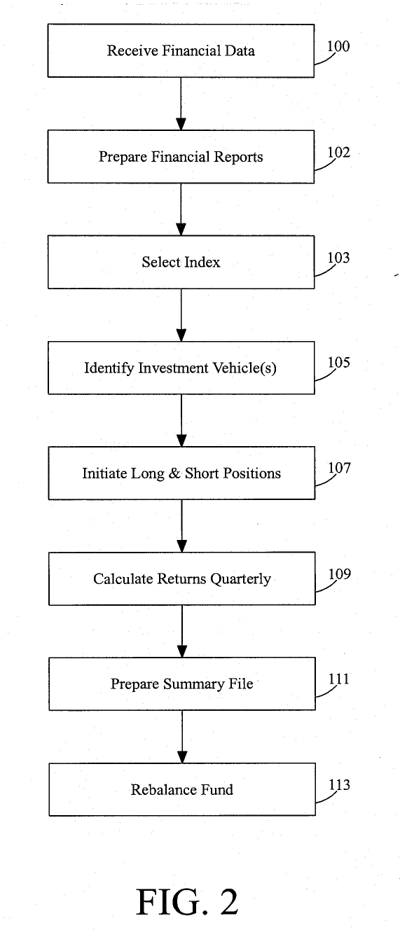

The computer system 50 may be used to electronically carry out the transactions described herein, and to conduct other processing/transactions in connection with the diversified premia fund. FIG. 2 illustrates operations performed in managing an investment portfolio in accordance with an exemplary embodiment. Additional, fewer, or different operations may be performed depending on the embodiment or implementation. The operations also may be performed in a different order than that presented. In an operation 100, financial data is received from a database. A number of databases can be provided by commercial and non-commercial entities that include real-time and non-real-time business and financial information associated with companies in a region or worldwide. An exemplary database includes data provided on a daily basis. The financial data may be sent from the database automatically or as requested. In an exemplary embodiment, the frequency of receipt of the data is quarterly. In an exemplary embodiment, the financial data is received into preset tables. Exemplary tables are associated with fund choice, future values, fund segment, etc. In an operation 102, financial reports are prepared using the financial data received.

In an operation 103, a representative index is selected for processing. In an operation 105, one or more least expensive investment vehicles are identified. In an operation 107, long and short positions are initiated on the investments. Equal weight is given to each return series. In an operation 109, the account values for all investments are compiled into a summary file. In an exemplary embodiment, the summary file is prepared quarterly, although other time periods may be used. Additionally, the summary file may include data such as investment fund investments and individual positions. The data may be updated on a periodic basis that may vary based on the data type. The data may be received electronically for example using the file transfer protocol (FTP), e-mail, facsimile, etc. In an operation 111, the prepared summary file is sent to a hedge model to evaluate the position of the funds allocated to accounts. In an exemplary embodiment, the hedge model is MG-HEDGE® a system for providing risk analysis and hedging of market exposures. In an exemplary embodiment, the summary file is send automatically on a periodic basis. A hedge report from the hedge model can be received electronically, for example through email, though other electronic means such as FTP, facsimile, etc. are contemplated. The hedge report may include a summary of liabilities to be hedged, a risk position report, a cash flow projection report, an option budget history report, etc.

In an operation 113, the investment fund is rebalanced. Rebalancing is the process whereby periodically the portfolio's exposure to different investments is adjusted back to each investment's targeted weight. For example, an equal-weighted portfolio of thirteen individual investments would allocate 7.7% ( 1/13) to each investment. After a period of time, the different investments produce various gains and losses causing their allocations to deviate away from the targeted 7.7%. Those with gains (winners) would have weights greater than 7.7%, while those with losses (losers) would have weights under 7.7%. Rebalancing would reduce the winner's weights back to the targeted 7.7% and increase the loser's weights up to 7.7% resulting in the targeted equal-weighting scheme.

It should be appreciated, of course, that the details associated with the diversified premia methodology described herein merely represents one possible implementation. The exemplary embodiments are described herein with reference to drawings. These drawings illustrate certain details of specific embodiments that implement the systems and methods and programs of the present invention. However, describing the exemplary embodiments with drawings should not be construed as imposing on the exemplary embodiments any limitations that may be present in the drawings. The exemplary embodiments contemplate methods, systems and program products on any machine-readable media for accomplishing it operations. The embodiments of the exemplary embodiments may be implemented using an existing computer processor, or by a special purpose computer processor incorporated for this or another purpose or by a hardwired system.

Embodiments within the scope of the present invention can include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which ca be used to carry or stored desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed machine-MADI readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Exemplary embodiments are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods described herein. The particular sequence of such executable instructions or associated data structures represent examples of corresponding acts for implementing the functions described in such steps.

Exemplary embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Exemplary embodiments may also be practiced in distributed computing environments where tasks are performed by local and remote processing devices that are linked (either by hardwired links, wireless links or by a combination of hardwired and wireless links) through a communications network. In a distributed computing environment, program modules may be located in both local and remote memory storage devices.

It should be noted that although the flow charts provided herein show a specific order of method operations or steps, it is understood that the order of these operations or steps may differ from what is depicted. Also two or more operations or steps may be performed concurrently or with partial concurrence. Such variation will depend on the software and hardware systems chosen and on designer choice. It is understood that all such variations are within the scope of the invention. Likewise, software and web implementations of the exemplary embodiments could be accomplished with standard programming techniques with rule based logic and logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of exemplary embodiments has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention in various embodiments and with various modifications as are suited to the particular use contemplated.

While several embodiments have been described, it is to be understood that modification and changes will occur to those skill in the art to which the invention pertains. Accordingly, the claims dependent to this specification are intended to define the invention more precisely.

What is claimed is:

1. A method of identifying eligible investments for inclusion in an investment fund, the method comprising:
selecting a first investment and a second investment;
determining whether the first investment and the second investment provide positive, historical excess return streams;
assessing a correlation between the first investment and the second investment; and
identifying a representative index and vehicle for the first and second investments if the assessed correlation is at or below a predetermined low correlation level.

2. The method of claim 1, further comprising assessing a second correlation between the first investment and a stock market index and a third correlation between the second investment and the stock market index.

3. The method of claim 1, wherein the predetermined low correlation level is 0.30.

4. The method of claim 1, further comprising establishing an investment fund including the identified representative index and vehicle.

5. The method of claim 4, further comprising establishing long and short positions on investments in the investment fund.

6. The method of claim 5, further comprising calculating returns on the investments periodically.

7. A system for identifying eligible investments for inclusion in an investment fund, the system comprising:
an interface coupled with a database containing investment information; and
a processor coupled to the interface, the processor being configured to:
select a plurality of investments;
determine whether the plurality of investments provide positive, historical excess return streams;
assess correlations between investments in the plurality of investments; and
identify a representative index and vehicle for investments with assessed correlations at or below a predetermined low correlation level.

8. The system of claim 7, wherein the processor is configured to assess a market correlation between a stock market index and investments in the plurality of investments.

9. The system of claim 7, wherein the predetermined low correlation level is 0.30.

10. The system of claim 7, wherein the processor is configured to establish an investment fund including the identified representative index and vehicle.

11. The system of claim 10, wherein the processor is configured to establish long and short positions on investments in the investment fund.

12. The system of claim 11, wherein the processor is configured to calculate returns on the investments periodically.

13. A computer program product for identifying eligible investments for inclusion in an investment fund, the computer program product comprising:
an interface for selection among a plurality of investments;
programmed instructions configured to determine whether the plurality of investments provide positive, historical excess return streams;
programmed instructions configured to assess correlations between investments in the plurality of investments; and
programmed instructions configured to identify a representative index and vehicle for investments with assessed correlations at or below a predetermined low correlation level.

14. The computer program product of claim 13, further comprising programmed instructions configured to assess a second correlation between the first investment and a stock market index and a third correlation between the second investment and the stock market index.

15. The computer program product of claim 13, wherein the predetermined low correlation level is 0.30.

16. The computer program product of claim 13, further comprising programmed instructions configured to establish an investment fund including the identified representative index and vehicle.

17. The computer program product of claim 16, further comprising programmed instructions configured to establish long and short positions on investments in the investment fund.

18. The computer program product of claim 13, further comprising programmed instructions configured to calculate returns on the investments periodically.

19. The computer program product of claim 13, further comprising programmed instructions configured to select different investments from the plurality of investments according to a targeted weight.

20. The computer program product of claim 13, wherein the interface comprises a communication interface to a network by which the interface receives data on the plurality of investments.
